(19) United States
(12) Patent Application Publication
(10) Pub. No.: US 2014/0269817 A1
(43) Pub. Date: Sep. 18, 2014

(54) Phosphor Thermometry Fiber Sensor

(71) Applicant: United Technologies Corporation, Hartford, CT (US)

(72) Inventor: Bruce Hockaday, Vernon, CT (US)

(73) Assignee: United Technologies Corporation, Hartford, CT (US)

(21) Appl. No.: 14/186,213

(22) Filed: Feb. 21, 2014

Related U.S. Application Data
(60) Provisional application No. 61/783,833, filed on Mar. 14, 2013.

(51) Int. Cl. G01K 11/32

(52) U.S. Cl. CPC G01K 11/32
USPC 374/9

(57) ABSTRACT

A high precision phosphor temperature sensor is disclosed. The sensor includes a light source that emits an excitation light through a first optical fiber to a Y-coupler or splitter that connects the first optical fiber to a second optical fiber and a third optical fiber. The second optical fiber connects the Y-coupler to a detector and the third optical fiber connects the Y-coupler to a sensing end of the third optical fiber that is coated with a phosphor that produces a fluorescent emission when engaged by excitation light generated by the light source. The third optical fiber then transmits fluorescent emissions from the phosphor through the Y-coupler whereby at least some of the fluorescent emission passes through the second optical fiber to the detector. The lifetime of the fluorescent emission can be measured and the temperature at the phosphor can be calculated from said lifetime.

### TECHNICAL FIELD

This disclosure relates to a phosphor based temperature sensors and temperature sensing methods. More specifically, this disclosure relates to a phosphor based temperature sensor and a temperature measuring method for measuring a temperature in accordance with the optical emission decay time of fluorescent light emitted by a phosphor after it has been excited with a light source.

### BACKGROUND

A phosphor is a substance that exhibits the phenomenon of luminescence. Phosphors include both phosphorescent materials, which show a slow decay in brightness (>1 ms), and fluorescent materials, where the emission decay takes place over tens of nanoseconds. This disclosure is concerned with fluorescent materials that are common in sensors, such as temperature sensors.

In a phosphor based temperature sensor, the temperature is measured using a phosphor wherein the fluorescent characteristics vary depending on the temperature. Specifically, the phosphor is exposed to an excitation light from a light source, e.g., a UV light source, and the fluorescent light produced by the phosphor is detected. The temperature is measured through the change in the characteristics of the fluorescent light, such as the fluorescent emission “lifetime” or decay constant.

The phosphor may be disposed at an end of a tube. When the excitation light is radiated from the light source, it is illuminated onto the phosphor through the tube. The fluorescent light that is produced by the phosphor is detected by a detector. The fluorescent intensity decays in accordance with equation I=Iₒe^{-t/τ}, where t represents time, Iₒ is the initial intensity at t=0, e represents the base of the natural logarithm (2.718 . . . ) and τ is the lifetime of the fluorescence. The lifetime τ is the slope of the natural log of the time dependent emission and is therefore a critical parameter used in determining temperature.

Thin coatings of phosphors, less than 50 micrometers thick, on components such as turbine rotors vanes and the like, have been activated by pulsed and steady-state light sources to produce fluorescence signals that are analyzed to yield temperature. The temperature dependence of the lifetime of the fluorescence results from the competition for allowed de-excitation processes that take place within excited dopant (activator) ions. At increasing temperatures, larger numbers of non-radiative (non-photon-emitting) transitions are allowed, thereby shortening the lifetime of photon emitting de-excitations through depopulation of the ionic excited states. Therefore, as the temperature increases, the characteristic fluorescence of these materials decreases in lifetime and intensity. Because the temperature sensitivity of the fluorescence is high for many phosphors, they can be used precise temperature measurements.

A complex engine like a gas turbine engine needs to be thoroughly instrumented in order to validate safe and correct operation. To operate such an engine efficiently, the temperatures at various places or “stations” within the engine need to be known. FIG. 1 is a sectional view of a gas turbine engine 10. The gas turbine engine 10 may include a fan assembly 11 that is mounted immediately aft of a nose cone 12 and immediately fore of a low pressure compressor (LPC) 13. A gear box (not shown) may be disposed between the fan blade assembly and the LPC 13. The LPC 13 may be disposed between the fan blade assembly 11 and a high pressure compressor (HPC) 14. The LPC 13 and HPC 14 are disposed fore of a combustor 15 which may be disposed between the HPC 14 and a high pressure turbine (HPT) 16. The HPT 16 is typically disposed between the combustor 15 and a low pressure turbine (LPT) 17. The LPT 17 may be disposed immediately fore of a nozzle 18. The LPC 13 may be coupled to the LPT 17 via a shaft 21 which may extend through an annular shaft 22 that may couple the HPC 14 to the HPT 16. An engine case 23 may be disposed within an outer nacelle 24. An annular bypass flow path may be created by the engine case 23 and the nacelle 24 that permits bypass airflow or airflow that does not pass through the engine case 23 but, instead, flows from the fan assembly 11, past the fan exit guide vane 26 and through the bypass flow path 25. One or more frame structures 27 may be used to support the nozzle 18.

The main reasons to continuously monitor gas turbine engine temperatures include: the ability to calculate the efficiency of compressors and turbines; the control of the engine power through all the different operating conditions where temperature monitoring at the different stations plays a major role; monitoring of high temperature components and temperature limits; and maintenance of a temperature history of the components to estimate their residual life.

Temperature measurements from thermocouples immersed in flowing gases include errors, primarily caused by heat transfer and variability of wire lots in thermoelectric signal generation capability, i.e., calibration. In particular heat transfer. occurs: through conduction along the wires and the sheath of the thermocouple; through radiation to/from the walls and the blades/vanes surfaces; through convection at the boundary layer around the thermocouple. Conduction and radiation give rise to two measurement errors called conduction error and radiation error respectively. Thermocouple wire sensitivity varies from lot-to-lot as shown in the tolerance of commercially available sensing wire.

Thus, there is a need for improved temperature sensor devices for high temperature, high gas flow velocity applications such as those encountered in gas turbine engines without resorting to thermocouples and their inherent disadvantages.

### SUMMARY

In one aspect, a temperature sensor is disclosed. The disclosed temperature sensor may include a light source that emits an excitation light through a first optical fiber. The first optical fiber may be connected to a second optical fiber and a third optical fiber at a Y-coupler. The second optical fiber connects the Y-coupler to a detector. The third optical fiber connects the Y-coupler to a sensing end of the third optical fiber that is coated with a phosphor. The phosphor produces a fluorescent emission when engaged by the excitation light. The third optical fiber may be used to transmit the fluorescent emission from the phosphor to the Y-coupler which transmits at least some of the fluorescent emission to the second optical fiber and on to the detector.

In another aspect, a gas turbine engine is disclosed. The gas turbine engine may include a plurality of temperature sensors. Each temperature sensor may include a light source that emits ultra-violet light into a first optical fiber. The first optical fiber may be connected to a second optical fiber and a third optical fiber at a Y-coupler. The second optical fiber connects the Y-coupler to a detector and the third optical fiber connects the Y-coupler to a sensing end of the third optical fiber that is coated with a phosphor that produces a fluorescent emission when engaged by the excitation light. The third optical fiber may transmit the fluorescent emission from the phosphor to the Y-coupler which may then transmit at least some of the fluorescent emission to the second optical fiber and onto the detector. Further, the detector may be linked to a controller having a memory programmed to determine a lifetime of the fluorescent emission from the phosphor and to calculate a temperature of the phosphor from the lifetime.

In yet another aspect, a method of measuring a temperature of gases passing through a gas turbine engine is disclosed. The method may include providing a first optical fiber connected to a second optical fiber and a third optical fiber at a Y-coupler. The method may further include coupling the first optical fiber to a light source and coupling the second optical fiber to a detector. The method may then include coating a sensing end of the third optical fiber disposed opposite the Y-coupler with a phosphor that produces fluorescent emission when engaged by an excitation light generated by the light source. The method may then further include transmitting excitation light from the light source through the first optical fiber, through the Y-coupler and through the third optical fiber to the phosphor. The method may then include generating a fluorescent emission at the phosphor and transmitting at least a portion of the fluorescent emission from the phosphor through the third optical fiber, through the Y-coupler and through the second optical fiber to the detector. The method may further include measuring a lifetime of the fluorescent emission and calculating the temperature at the phosphor from the lifetime of the fluorescent emission.

In any one or more of the embodiments described above, the sensing end of the third optical fiber and the phosphor may be coated with an opaque material.

In any one or more of the embodiments described above, the light source may be an ultra-violet light source. In a further refinement of this concept, the ultra-violet light source may be solid state.

In any one or more of the embodiments described above, the detector may be a photo detector.

In any one or more of the embodiments described above, the detector may be linked to a controller having a memory programmed to calculate temperature from a lifetime of the fluorescent emission.

In any one or more of the embodiments described above, the phosphor may be selected from, but not limited to, the group consisting of YVO₄:Dy; Y₂O₃:Dy; Mg₄FGeO₆:Mn; YVO₄:Eu; Y₂O₃:Eu; YAG:Tb; YAG:DY; YAG:Eu; and LuPO₄:Dy.

In any one or more of the embodiments described above, the Y branch splitting ratio may be adjusted as a function of optical wavelength allowing substantially larger fraction of the emission to travel to the detector instead of traveling to the UV light source.

### BRIEF DESCRIPTION OF THE DRAWINGS

FIG. 1 is a sectional view of a disclosed gas turbine engine illustrating various points or stations where the disclosed temperature sensors may be employed.

FIG. 2 is a schematic illustration of a disclosed temperature sensor.

FIG. 3 graphically illustrates the relationship between fluorescent emission lifetime and temperature.

### DESCRIPTION

The most important parameter of the engine 10 to be monitored is temperature. In the operation of a dual shaft jet engine, shown schematically FIG. 1, air enters the LPC inlet 31 and is compressed until the air exits the LPC exit 32 thereby resulting in an increase in the air temperature and pressure. Air is then compressed as is passes from the HPC inlet 33 to the HPC exit 34 thereby resulting in another increase in air temperature and pressure. In the combustor 15, compressed air is mixed with fuel and combustion takes place. The combustion gases exit the combustor outlet 35 at higher temperature than at the combustor inlet 36 and with almost the same pressure. The combustion gases are expanded in the HPT 16 from the HPT inlet 37 to the HPT outlet 38 resulting in a reduction in pressure and temperature. The combustion gases are further expanded in the LPT 17 from its inlet 41 to its outlet 42 with another reduction in pressure and temperature. The gases are then released to the atmosphere past the nozzle 18. The following “stations” are commonly instrumented with thermocouples: LPC inlet 31; LPC outlet 32 or HPC inlet 33; HPC outlet 34 or combustor inlet 36; combustor outlet 35 or HPT inlet 37; HPT outlet 38 or LPT inlet 41; and the LPT outlet 42.

FIG. 2 schematically illustrates a sensor 50 that may be employed at any of the stations described above. The sensor 50 includes a first optical fiber 51 that couples a light source 52 to a Y-coupler 53. The Y-coupler 53 connects the first optical fiber 51 to a second optical fiber 54 and a third optical fiber 55. The second optical fiber 54 couples the Y-coupler 53 to a detector 56 which, as shown in FIG. 2 may be linked to a controller or microprocessor 57. The controller or microprocessor 57 may also be linked to the light source 52. The third optical fiber 55 couples the Y-coupler 53 to a sensing end 58 of the third optical fiber 55 which may be coated with a phosphor 59. The phosphor 59 and sensing end 58 may also be coated with an opaque material shown schematically at 61.

Turning to FIG. 3, the selection of the particular phosphor 59 will depend upon the anticipated temperature range. For example, Y₂ O₃:Dy is suitable for a narrow temperature range just below 800° K. However, Y₂ O₃:EU is effective, or provides a straight line slope from about 800° K through about 1400° K. YAG:Eu and YAG:Tb are suitable for narrower, but higher temperature ranges than Y₂ O₃:Eu. While LaO2S2:Eu has series of emission peaks at different optical wavelengths enabling temperature measurements below 600K.

Returning to FIG. 2, the Y-coupler is utilized so that at least some of the fluorescent emission from the phosphor 59 passing through the third optical fiber 55 reaches the second optical fiber 54 and the detector 56. In one aspect, the splitting ratio of the Y-coupler 53 could be set as function of wave length allowing most of the fluorescent emission to travel through the second optical fiber 54 to the detector 56, given the fact that excitation wave lengths, such as that produced by the light source 52, and emission wave lengths, such as that produced by the phosphor 59, are relatively far apart. Further, a precise amplitude signal is not required at the detector 56 because the fluorescent emission decay time or lifetime will be constant for a given temperature, as shown in FIG. 3, and will therefore be insensitive to amplitude.

### INDUSTRIAL APPLICABILITY

As shown in FIG. 3, the various phosphors illustrated correlate fluorescent emission lifetime to temperature with a relatively high precision. Thus, accurate temperature measurements can be made at the compressors 13, 14, turbines 16, 17, or combustor 15 and these temperature measurements could be used to monitor and improve the operational characteristics of the fan 11, the compressors 13, 14, the turbines 16, 17 and the compressor 15. Monitoring the temperatures can also be used to monitor high temperature components and their temperature limits and assist with maintenance by recording temperature histories of selected parts. Further, the temperature measurements do not require knowledge of the absolute temperature. Specifically, two probes utilized that include the same phosphor or same batch of phosphor will have identical temperature-time constant calibration curves as shown in FIG. 3. Thus, the results of both measurements will share the same systematic errors which will cancel out when calculating a temperature rise or a temperature decrease.

The disclosed use of optical fibers 51, 54, 55 can be a direct replacement for conventional thermal couples, which are still in use. The light source 52 can be a solid state UV light source and the temperature sensors could be confined within a small space thereby eliminating the need for technicians to have to work with optical fibers. Further, adding electronics, such as a microprocessor 57, could permit the creation of a networked probe architecture where data will travel on a single cable as a serial stream from the probes.

1. A temperature sensor comprising:
a light source emitting an excitation light into a first optical fiber;
the first optical fiber being connected to a second optical fiber and a third optical fiber at a Y-coupler;
the second optical fiber connecting the Y-coupler to a detector;
the third optical fiber connecting the Y-coupler to a sensing end of the third optical fiber that is coated with a phosphor that produces a fluorescent emission when engaged by the excitation light; and
the third optical fiber transmitting the fluorescent emission from the phosphor to the Y-coupler which transmits at least some of the fluorescent emission to the second optical fiber and on to the detector.

2. The temperature sensor of claim 1 wherein the sensing end of the third optical fiber and the phosphor are coated with an opaque material.

3. The temperature sensor of claim 1 wherein the light source is an ultra-violet light source.

4. The temperature sensor of claim 1 wherein the light source is a solid state ultra-violet light source.

5. The temperature sensor of claim 1 wherein the detector is a photo detector.

6. The temperature sensor of claim 1 wherein the detector is linked to a controller having a memory programmed to calculate temperature from a lifetime of the fluorescent emission.

7. A gas turbine engine comprising:
a plurality of temperature sensors, each temperature sensor including
a light source emitting ultra-violet light into a first optical fiber,
the first optical fiber being connected to a second optical fiber and a third optical fiber at a Y-coupler,
the second optical fiber connecting the Y-coupler to a detector;
the third optical fiber connecting the Y-coupler to a sensing end of the third optical fiber that is coated with a phosphor that produces a fluorescent emission when engaged by the excitation light;
the third optical fiber transmitting the fluorescent emission from the phosphor to the Y-coupler which transmits at least some of the fluorescent emission to the second optical fiber and on to the detector; and
the detector linked to a controller having a memory programmed to determine a lifetime of the fluorescent emission from the phosphor and to calculate a temperature of the phosphor from the lifetime.

8. The temperature sensor of claim 7 wherein the sensing end of the third optical fiber and the phosphor are coated with an opaque material.

9. The temperature sensor of claim 7 wherein the light source is a solid state ultra-violet light source.

10. The temperature sensor of claim 7 wherein the detector is a photo detector.

11. A method of measuring a temperature of gases passing through a gas turbine engine, the method comprising:
providing a first optical fiber connected to a second optical fiber and a third optical fiber at a Y-coupler;
coupling the first optical fiber to a light source;
coupling the second optical fiber to a detector;
coating a sensing end of the third optical fiber disposed opposite the Y-coupler with a phosphor that produces fluorescent emission when engaged by an excitation light generated by the light source;
transmitting excitation light from the light source through the first optical fiber, through the Y-coupler and through the third optical fiber to the phosphor;
generating a fluorescent emission at the phosphor;
transmitting the fluorescent emission from the phosphor through the third optical fiber, through the Y-coupler and through the second optical fiber to the detector;
measuring a lifetime of the fluorescent emission; and
calculating the temperature at the phosphor from the lifetime of the fluorescent emission.

12. The method of claim 11 further including coating the sensing end of the third optical fiber and the phosphor with an opaque material.

13. The method of claim 11 wherein the light source is a ultra-violet light source.

14. The method of claim 11 wherein the light source is a solid state ultra-violet light source.

15. The method of claim 11 wherein the detector is a photo detector.
